(19) United States
(12) Patent Application Publication
(10) Pub. No.: US 2026/0250892 A1
(43) Pub. Date: Aug. 27, 2026

(54) SEAMLESS TUBULAR KNITTED FABRIC, COMPRISING AN OPEN KNIT WITH WEFT BUSHING LOCKING TO PREVENT UNRAVELING

(71) Applicant: VISCORET ELASTIC NETS S.R.L., Lomagna (Lecco) (IT)

(72) Inventor: Andrea MONTINI, Lomagna (IT)

(21) Appl. No.: 19/435,259

(22) Filed: Dec. 29, 2025

(30) Foreign Application Priority Data
Dec. 30, 2024 (IT) 102024000030144

(51) Int. Cl. D04B 1/06; A22C 13/00; A23L 13/60; B65D 30/00; D04B 1/10; D04B 1/22

(52) U.S. Cl. CPC D04B 1/06; A22C 13/00; A23L 13/65; B65D 29/00; D04B 1/104; D04B 1/22; A22C 2013/0056; D10B 2505/10

(57) ABSTRACT

A seamless tubular weft-knitted fabric has one or more weft ends extending in a continuous spiral, forming a plurality of overlapping rows. Each row has a plurality of weft bushings, each interconnected with a loop of an adjacent superimposed row. The seamless tubular weft-knitted fabric has parallel and spaced apart longitudinal chains, crocheted from separate ends, forming wrap rings. Each wrap ring is interconnected with a weft bushing, ensuring that all weft bushings are securely interconnected with a wrap ring. The configuration of the seamless tubular weft-knitted fabric prevents fraying upon cutting, making the seamless tubular weft-knitted fabric ideally suited for applications requiring a strong and durable fabric.

### CROSS-REFERENCE TO RELATED APPLICATION

This application claims priority to Italian Patent Application No. 102024000030144, filed on Dec. 30, 2024, the contents of which are incorporated by reference in their entirety.

### FIELD OF THE INVENTION

The present invention relates to textile production, specifically seamless tubular weft-knitted fabrics designed to prevent unraveling upon cutting.

The document pertains to textile production, specifically the development and manufacture of seamless tubular weft-knitted fabrics.

These fabrics are engineered to preserve their structural integrity and prevent unraveling upon cutting, which is particularly advantageous in applications such as sausage nets and other packaging solutions.

Specifically, the present invention pertains to a particular combination of weft and warp knitting techniques, designed to produce a fabric that retains the same elasticity and unravelability characteristics of current bielastic tubular nets on the market, in the field of automatic production and packaging of sausages for curing, but which also achieves the additional advantages of a weft-knitted fabric, namely, greater adaptability to a wider range of shapes and sizes of the products to be packaged.

### STATE OF THE ART

Textile production involves the creation of fabrics and materials through various knitting, weaving, and other textile production methods. Seamless tubular weft-knitted fabrics are a textile product type characterized by a continuous and uninterrupted structure.

These fabrics are utilized in diverse sectors, encompassing food processing, packaging, and the medical domain, where the preservation of product form and integrity is paramount.

For example, in the sausage industry, seamless tubular knitted fabrics/nets are utilized to wrap the products and preserve their shape throughout the curing or cooking process.

These fabrics are typically constructed from tubular knitted fabric, forming a plurality of superimposed turns of knitted courses.

The primary objective in this sector is to produce a net that can be used to efficiently enclose products, while ensuring that the net maintains its structural integrity throughout the entire process.

There are commercially available simple weft knitted nets/fabrics (stockinette stitch or jersey), produced by elastic twine binding machines, which construct the fabric directly around the sausage to be packaged.

This fabric exhibits excellent longitudinal and transverse extensibility, rendering it suitable for a wide range of shapes and sizes. This characteristic, combined with the elasticity of the yarn employed, further enhances its adaptability.

A main problem in this field is to prevent the unraveling of the weft-knitted fabric upon cutting or subsequent to a partial rupture.

These fabrics, when used for sausages, form netted fabrics, or nets, which must be sewn around the product to be packaged, thereby increasing the complexity of the packaging operation and the risk of unraveling. Documents US1520162A and FR2508276A1 describe apparatuses capable of making such nets around the sausage.

There is, however, a specific sector within the field of meat and sausage processing and packaging (as well as other sectors, such as the medical field), where nets are produced using specialized circular machines. These machines employ mixed techniques from the fields of weft and warp knitting, with the main purpose of maintaining the shape and structural integrity of such foods during aging or cooking.

These nets are characterized by being tubular, possessing uniform aesthetic characteristics, being seamless, and remaining unravelable after cutting. They may be rigid or elastic. They can be manufactured with varying diameters, a different number of panels, and with differing dimensions and proportions of these panels. They are manufactured from various types of yarns (natural rubber, cotton, polyester, polyethylene, polypropylene, etc.) and in various thicknesses, which are more or less suitable for curing or cooking processes.

These nets comprise a series of mutually independent warp chains (crochet chains), held together by continuous, spiral turns of one or more elastic (or rigid) wefts simultaneously, which interlace with the warp chains. The warp chains will define the longitudinal structure, while the weft will define the transverse structure.

Document US3513668A discloses a net possessing such characteristics and produced by a circular knitting machine. The document provides a detailed description of the mechanical apparatus, including the yarn guides, cams, and the rotation mechanism, which enable the creation of such a net. The drawings depict the various components of the machine and the weaving process, illustrating the arrangement of the warp and weft yarns to achieve the desired outcome.

A more recent innovation pertains to the introduction of the weft yarn from within the virtual cylinder formed by the warp yarns. Documents GB2210632A and IT1248718B describe the operation of an apparatus capable of performing this operation.

Document ITMI980409U1 describes a bielastic net that utilizes the production method of document US3513668A, for use in the processing and packaging of sausages to be cured, particularly non-minced sausages.

Prefabricated bielastic nets enable packaging with machines that automatically press, stuff, and clip the product, thereby separating the net manufacturing phase, which can be optimized by a specialized net manufacturer.

There is therefore a need to provide a simple weft knitted fabric (stockinette stitch or jersey), possessing excellent extensibility both longitudinally and transversely, which can be produced separately from the packaging process and which nevertheless maintains its integrity once cut.

Therefore, the need remains to produce a tubular fabric separately from the object to be packaged or simply wrapped, which allows for two conflicting requirements: a bi-elastic capacity, i.e., an extensibility in two orthogonal directions, typically the longitudinal direction of extension of the product to be wrapped and the transverse direction, and on the other hand, to block the unraveling and disintegration of the knit capable of this bi-elasticity, making it possible to produce the tubular fabric separately from the product to be wrapped.

In other words, considering the solutions of the prior art, machines and nets as taught in the aforementioned document US3513668A, produce nets with a simply linear weft, not a weft knit. Indeed, in these machines and the tubular fabrics produced with them, there are no weft bushings interconnected with another weft bushing of an adjacent row.

Furthermore, in the known nets, the weft is linear and interconnected/embedded only in warp chains. These nets, although unravelable, do not address the perceived need for the desired bi-elasticity.

Similarly, even the bi-elastic fabrics cited in ITMI980409U1, wherein the warp yarns are also elastic, do not address the aforementioned requirement.

Therefore, by proceeding in this manner, the desired bi-elasticity of the weft knit, possessing a natural capacity for rebalancing longitudinal and transverse elasticity, is entirely lost.

The ongoing need, however, pertains to rendering nets produced by technologies such as those described in US1520162A and FR2508276A1, wherein a weft knit (with interconnected loops) is produced by sewing an elastic cord directly onto the bagged product, resistant to unraveling upon cutting. These nets are elastic both longitudinally and transversely, with the weft knit only. However, in these solutions, there remains a strong need to prevent the unraveling and disintegration of this weft knit when it is cut.

### SUMMARY OF THE INVENTION

An object of the present invention is to overcome the drawbacks of the prior art and to provide a seamless tubular weft-knitted fabric incorporating a combination of weft and warp knitting techniques to create a durable and reliable fabric. This fabric prevents unraveling when it is cut anyway, thereby addressing the limitations of existing net products on the market.

The present invention enables the combination of the advantages of a pre-fabricated, biaxially elastic, unravelable net with the benefit of greater adaptability, of elastic weft-knit nets sewn directly around the bagged product.

The fabric of the present invention possesses the same technical characteristics of elasticity and adaptability as the weft-knitted net produced by elastic twine binding machines, with the advantage of being unravelable and, therefore, capable of being prefabricated and freely cut at any point without the need to block its ends. It can also be fitted to the product at a later time using machines that automatically press, stuff, and clip it, thereby saving production time and costs.

When the net-shaped fabric is fitted onto two products of different diameters, the loops (shaped into a loop) will tend to extend more horizontally (transverse to the longitudinal axis of the product or direction of bagging) and retract vertically (longitudinal, or in the longitudinal direction of the product or direction of bagging) on the product with the larger diameter, and vice versa on the product with the smaller diameter, with a compression force that tends to be uniform between the vertical and horizontal forces.

By modifying the longitudinal tensile intensity of the net, it is possible to alter the design of the rectangular weft bushing and the compression force (including the transverse force), while maintaining a greater balance between the longitudinal and transverse compression forces compared to the bielastic nets of the prior art.

This and other objectives are achieved by a seamless tubular weft-knitted fabric, a method for producing the seamless tubular weft-knitted fabric, and a processed meat-based product enclosed in a tubular weft-knitted fabric as described and claimed herein.

Certain advantageous embodiments are described.

According to one aspect of the present invention, a seamless tubular weft-knitted fabric comprises a combination of weft and warp knitting techniques to create a durable and reliable fabric that prevents unraveling when cut, particularly when cut at any point.

According to another aspect, the seamless tubular weft-knitted fabric comprises a plurality of overlapping turns of stitches, thereby ensuring that the fabric maintains its structural integrity.

According to a further aspect, the seamless tubular weft-knitted fabric is designed for applications such as sausage netting and other packaging solutions, where maintaining the shape and integrity of the product is essential.

One aspect of the present invention resides in the unique combination of weft and warp knitting techniques to create a seamless tubular weft knitted fabric that prevents unraveling when cut. Unlike traditional solutions, which must be constructed around the product to prevent unraveling, the present invention enables the net to be produced independently of the packaging process, while maintaining its structural integrity.

The fabric comprises a plurality of overlapping turns of stitches, with each weft bushing interconnecting with a wrap ring, thereby ensuring that the fabric remains intact even after being cut.

This innovative approach addresses the limitations of existing net products and provides a more efficient and cost-effective solution for applications such as sausage netting and other packaging requirements.

This invention relates to a seamless tubular weft-knitted fabric. The fabric comprises one or more weft ends extending in a continuous spiral, forming part of the fabric and creating a series of overlapping rows(or courses). Each row contains several weft bushings, each interconnected with a loop from a nearby, superimposed row. Furthermore, the fabric comprises parallel and spaced warp chains, crocheted from separate warp ends, forming warp rings. Each warp ring is interconnected with a weft bushing, ensuring that the fabric does not unravel when cut.

In one embodiment, the weft bushings may comprise stockinette stitches or jersey stitches. In another embodiment, they may be exclusively stockinette stitch.

In one embodiment, comprising at least three ranks, each weft bushing may be U-shaped, with arms interlacing with the loops of the upper and lower ranks. The warp rings may be formed by chain stitches of closed pillar stitches. Each warp stitch chain features a “U” loop, with arms that wrap around and intertwine with weft bushings, ensuring stability and preventing unraveling.

The fabric may be constructed from elastic or non-elastic weft yarns and is suitable for use as a net for sausages.

The production method comprises extending the weft ends in a continuous spiral, forming overlapping rows, and interconnecting the warp rings and weft bushings.

The fabric is configured to prevent unraveling and can be customized with various elastic characteristics. It is suitable for wrapping and containing sausages or packaged products.

The present invention also relates to a method for producing a seamless tubular weft-knitted fabric.

This method comprises several steps: providing one or more weft ends, extending them in a continuous spiral to form overlapping rows, and interconnecting weft bushings with warp rings. The warp chains are crocheted from separate ends, forming loops that intertwine with each weft bushing to ensure that the fabric does not fray when cut.

In one embodiment of the method, the weft bushings are formed in Jersey stitch or stockinette stitch, while the warp rings are created with chain stitches of closed pillar stitches. In accordance with one embodiment, the weft ends may be formed from elastic yarn, and the warp chains from non-elastic yarn. Furthermore, the fabric can be customized by utilizing multiple weft and warp yarns possessing distinct characteristics.

The seamless tubular weft-knitted fabric is particularly suitable for use as a net for sausages or packaged products.

Its configuration ensures that the product remains intact and does not unravel, thereby providing a reliable solution for various packaging applications.

Furthermore, the present invention is also applicable to processed meat products enclosed within this type of fabric, ensuring that the product maintains its integrity during use.

Thanks to the present invention, it is possible to obtain a greater number of meters of loadable fabric on the net-loading tube. The net-loading tube is the primary means used by cured meat producers/meat processing companies to apply the nets onto their products. The tubes may be of various diameters, materials, and lengths, for manual use or mounted on automatic machines.

Commercially available bi-elastic nets present the longitudinal component formed by chains of closed-loop pillar stitches of covered elastic yarn. When the net is mounted on the net-loading tube, the chains will bend and overlap, presenting a certain rigidity which will limit the compression of the net on the vertical.

The nets of the present invention present the longitudinal component composed of the legs of the weft stitch loop, of covered elastic yarn. This configuration is less rigid, and permits a greater compression of the net on the vertical, thus enabling more fabric to be loaded onto the net-loading tube.

In addition to this, the nets of the present invention present on average a greater longitudinal elongation compared to commercially available bi-elastic nets. The quantity of packageable products with a net-loading tube filled with net of the present invention is at least 80-90% greater, compared to if the tube is filled with bi-elastic nets currently on the market.

Furthermore, thanks to the present invention, it is possible to obtain the facilitated removal of the net at the end of its action and use on the final product. At the end of its working cycle for the curing of cured meats, the net is cut transversely at the extremity of the piece of meat.

With commercially available bi-elastic nets, the removal of the net from the product is an operation almost in reverse compared to its mounting, which must therefore be performed by pulling downwards the open side of the net after the cut.

This is necessary because the transverse cut determines only the breakage of the vertical chains, without influencing the elasticity and pressure of the weft which continues to act transversely. In these nets, the longitudinal and transverse elastic component are independent.

With the nets of the present invention, the longitudinal component and the transverse elastic component are formed by the same elastic yarn which forms the weft stitch; the longitudinal component is composed of the legs of the weft stitch loop, the transverse component is composed of the feet of the weft stitch loop.

This implies that a transverse cut of the net of the present invention determines a loss of hold and elastic pressure of both the transverse and longitudinal component.

The practical effect after the cut is evidenced by a rapid and almost automatic detachment of the net from the final product, thus rendering the removal of the net less strenuous.

### BRIEF DESCRIPTION OF THE FIGURES

Further features and advantages of the present invention will become apparent from the following description of its preferred embodiments, provided by way of non-limiting example, with reference to the accompanying figures, wherein:

FIG. 1 depicts interconnected weft bushings, arranged in overlapping rows or spiral turns, forming a single vertical interconnection, referred to as a weft knit rib (oriented vertically in the depicted figure). Specifically, this figure illustrates a jersey stitch or “stockinette stitch”.

FIG. 2 depicts warp rings, thereby forming a vertical chain (vertical in the direction of the depicted figure); specifically, this figure illustrates a closed-loop pillar stitch.

FIG. 3 illustrates two rounds of seamless tubular weft-knitted fabric with two starts and two weft spirals; specifically, two rows (or two spiral rounds) are depicted, each comprising twenty-four weft bushings, originating from two starts interlaced in a jersey stitch or “stockinette stitch”.

FIG. 4 illustrates a first embodiment of the present invention, featuring interconnected weft bushings between superimposed rows or spiral turns, represented in a single vertical interconnection (vertical in the direction of the depicted figure). Specifically, a jersey stitch or “stockinette stitch” is shown, wherein three weft bushings are interlaced with warp rings, thereby forming a plurality of vertical chain loops (vertical in the direction of the depicted figure), where each loop is interlaced with a weft stitch of a row or spiral turn. Specifically, a warp ring is depicted as a closed-loop pillar stitch.

FIG. 5 illustrates the fabric based on the embodiment of FIG. 4, wherein three vertical chains of warp rings are interlaced with five rows (or ranks) of seamless tubular weft-knitted fabric with a single start.

FIG. 6 depicts a seamless tubular weft-knitted fabric according to the present invention, as shown in FIG. 5; the fabric is shown in a tubular form, highlighting the continuous spiral arrangement of the weft stitches and the interconnection with the plurality of warp stitch chains.

FIG. 7 illustrates a fabric based on the embodiment of FIG. 4, comprising a tubular weft knit without seams with at least two starts, wherein three vertical chains of warp rings are interlaced with five turns (or rows) of tubular weft knit fabric without seams with at least two starts (represented in the figure with a white and a gray thread).

FIG. 8 depicts a seamless tubular weft-knitted fabric according to the present invention; the fabric is shown in a tubular form, highlighting the continuous spiral arrangement of the two-start weft stitches and the interconnection with the plurality of warp stitch chains.

FIG. 9 illustrates a second embodiment of the present invention, which, compared to the first embodiment illustrated in FIG. 4, features inverse weaves, as it is produced on circular looms rotating in the opposite direction.

FIG. 10 illustrates the fabric based on the embodiment of FIG. 9, wherein three vertical chains of warp rings are depicted, interlaced with five courses (or rows) of seamless tubular weft-knitted fabric, predominantly single-start.

FIG. 11 illustrates a fabric based on the embodiment of FIG. 9, a tubular weft knitted fabric without seams, with at least two starts, wherein three vertical chains of warp rings are interlaced with five rows (or ranks) of tubular weft knitted fabric without seams, with at least two starts (represented in the figure with a white and a gray thread).

FIG. 12 illustrates a third embodiment of the present invention, which, compared to the first embodiment illustrated in FIG. 4, exhibits a variation in the weave, as it is produced on circular looms wherein the weft originates from within the virtual cylinder of the warp yarns.

FIG. 13 illustrates the fabric based on the embodiment scheme of FIG. 12, wherein three vertical chains of warp rings are depicted, interlaced with five courses (or rows) of seamless, single-start tubular weft-knitted fabric.

FIG. 14 illustrates a fourth embodiment of the present invention, which, compared to the third embodiment illustrated in FIG. 12, features inverse weaves, as it is produced on circular looms rotating in the opposite direction.

FIG. 15 illustrates the fabric based on the embodiment scheme of FIG. 14, wherein three vertical chains of warp rings are depicted, interlaced with five turns (or rows) of tubular weft knitted fabric without seams, predominantly single-start.

FIG. 16 illustrates a bagged product 20 enclosed within a seamless tubular weft-knitted fabric 1, highlighting its longitudinal component 25 and transverse component 26.

### DETAILED DESCRIPTION

The following are some definitions that are useful for better understanding the detailed description of the preferred embodiments.

### Definitions

Ends or weft yarns: These are the yarns or starts. These extend in a continuous spiral, forming a tubular knitted fabric. Each weft end forms a plurality of overlapping turns, with each turn consisting of multiple weft bushings.

Weft bushings: Each weft bushing of each turn is interconnected with a neighboring weft bushing, that is, of a neighboring superimposed turn.

Warp chains: A plurality of parallel, spaced, and independent longitudinal warp chains, continuously crocheted from separate warp ends. These warp chains form warp rings that interconnect with the weft bushings. Each warp chain remains separate from the adjacent warp chains.

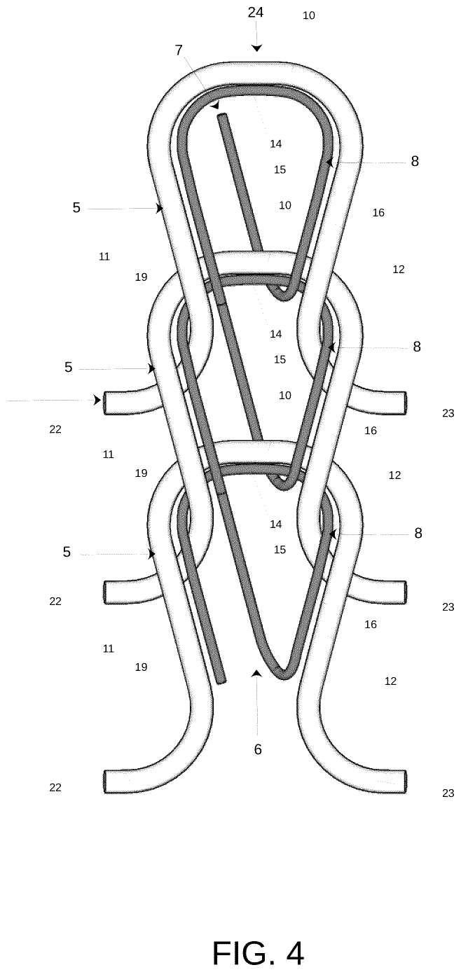

Warp rings: Each warp ring is interconnected with a weft bushing, ensuring that all weft bushings are securely interconnected with a warp ring. This configuration prevents the fabric from unraveling when cut. For example, FIG. 4 illustrates the general structure and arrangement of the weft bushings and warp rings, highlighting the interconnection that imparts the fabric with its unique properties of elasticity, strength, and anti-snagging. The seamless tubular weft knitted fabric is engineered to maintain its integrity and prevent unraveling, rendering it suitable for applications such as sausage netting and other packaging solutions.

Seamless tubular weft-knitted fabric with interconnected weft bushings and warp: This aspect of the invention pertains to a seamless tubular weft-knitted fabric wherein one or more weft ends extend in a continuous spiral, forming a tubular knitted fabric, and forming a plurality of overlapping turns. Each round comprises a plurality of weft bushings, with each weft bushing of each round being interconnected with a neighboring weft bushing of a nearby overlapping round. Furthermore, a plurality of parallel and spaced longitudinal warp chains are continuously crocheted from separate warp ends, forming warp rings. Each warp ring is interconnected with a weft bushing, ensuring that all weft bushings are interconnected with a warp ring. This configuration prevents the fabric from unraveling when cut.

Weft bushings Formed by Jersey Stitch: In accordance with one embodiment, this aspect of the invention relates to the formation of weft bushings using the jersey stitch, commonly known as stockinette stitch. The specific formation of weft bushings contributes to the overall structure and integrity of the seamless tubular weft knitted fabric.

Warp Rings Formed by Closed Pillar Stitch Chain Stitches: In accordance with one embodiment, this aspect of the invention relates to the formation of warp rings using closed pillar stitch chain stitches. The detailed description of the warp ring formation process, including the use of separate, controlled weft and warp yarns supplied for each loop, constitutes an aspect of this invention.

Use of Elastic and Non-Elastic Yarns: In accordance with one embodiment, this aspect of the invention includes the use of one or more weft ends made of elastic yarns and longitudinal warp chains made of substantially non-elastic yarn. The combination of elastic and non-elastic yarns contributes to the fabric's properties and functionality. The combination of elastic yarns in the weft and non-elastic yarns in the warp contributes to the fabric's properties and functionality. The elastic threads enable the fabric to conform to the product's shape, thereby ensuring a secure hold during the curing process. Conversely, the non-elastic yarns provide the requisite strength and durability to preserve the structural integrity of the fabric. This combination renders the fabric ideally suited for use as a sausage net, offering a robust and durable product that prevents unraveling upon cutting.

The warp yarn, which forms the warp chains, is primarily employed to render the weft knit unravelable. This yarn must be as light and economical as possible. Incorporating an elastic warp yarn would incur unnecessary additional costs, as such a yarn would be heavier and more expensive than a non-elastic yarn, such as a polyester, polyethylene, or polypropylene yarn. Furthermore, it is the weft knit itself, with its longitudinal component (and its shape), to produce the vertical elasticity. An elastic warp chain would therefore be superfluous for generating vertical elasticity. The elastic weft knit enables the generation, with a single thread, of both the vertical (longitudinal) and the horizontal (transverse) elastic components.

Examples of elastic yarns include: natural rubber covered by spiral winding with cotton or polyester, or a combination thereof.

Examples of non-elastic yarns include: polyester, cotton, polyethylene, or polypropylene.

Multiple Weft and Warp Yarns with Distinctive Characteristics: In accordance with one embodiment, this alternative aspect of the invention pertains to the utilization of multiple weft yarns possessing differing elastic characteristics and multiple warp yarns possessing differing characteristics. The variation in the properties of the yarns allows for the customization of the fabric's performance and behavior. For example, it is possible to increase the compression force of the elastic net by introducing a weft composed of more than one elastic thread, or one or more elastic threads of greater diameter, or it is possible to modify the elongation of the elastic weft, correcting the spiral of the rubber with non-elastic yarns, with a more or less dense, or more or less compressed covering.

Sausage Net: In accordance with one embodiment, this aspect of the invention relates to the application of seamless tubular weft knitted fabric as a sausage net. The specific use of the fabric in the sausage industry addresses the problem of maintaining the product's shape during the curing process, while simultaneously preventing unraveling upon cutting. One aspect of the present invention is the anti-unraveling property conferred by the interconnection of weft bushings with warp rings. This property enables the production of the sausage net separately from the sausage product and the cutting of the net to size before or after it has been fitted over the sausage product.

Product Enveloped with Mesh: In accordance with one embodiment, this aspect of the invention relates to the use of seamless tubular weft knitted fabric as a mesh for enveloped products. The application of the fabric in various packaged products demonstrates its versatility and utility in diverse contexts.

Closed-loop pillar stitch: This is a specific sewing or knitting technique in which the “pillar” stitches are worked with a “closed loop,” a stitch formation that ensures greater stability and solidity to the fabric. The closed-lap pillar stitch is a type of stitch predominantly utilized in industrial knitting or machine processing techniques, particularly for creating robust and stable fabrics. This stitch is characterized by its solidity and resistance, attributable to its vertically interlaced ring structure.

### Detailed Description of the Shape of the Closed-Loop Pillar Stitch

Vertical structure: The pillar stitch forms a vertical column of stitches, or “pillars.” Each pillar comprises a series of rings that are machined to connect tightly with one another, one above the other, thereby creating a vertical and stable structure. Each ring is interconnected with the lower ring, and all the rings in the column collaborate to impart solidity and strength to the fabric.

Closed-lap: The characteristic of the closed-lap indicates that each stitch is worked in such a way as to create a completely closed loop, without openings or spaces between the stitches. This is achieved by passing the thread through a portion of the pre-existing stitch and looping the thread so that the stitch closes upon itself. Unlike the “open loop,” where the ring may have visible gaps, in the closed loop, the thread completes a full turn around the preceding stitch, forming a tight and well-connected ring.

Appearance and function: The closed-loop pillar stitch imparts a highly compact and stable structure to the fabric. The column of stitches appears visually solid and linear, with each loop fully closed and connecting tightly to those above and below it. This structure prevents the fabric from deforming or fraying easily, making it ideal for applications where high strength is required, such as in the case of sausage nets or other weft-knitted fabrics.

### How the Stitch Appears

The fabric, constructed with closed-loop pillar stitches, features well-defined columns of stitches that run vertically along the fabric's length. These columns appear as repeating “lines” of stitches, one above the other, creating a uniform and regular structure. Each stitch in the column is a closed loop, meaning there are no gaps between the stitches, and the fabric is more robust and resistant to unraveling. Due to the complete closure of the loops, the closed-loop pillar stitch contributes to a fabric that can be cut without risking easy unraveling, a crucial aspect in technical applications.

### Main Functionality

The closed-loop pillar stitch is selected for its durability, strength, and stability within the fabric. The stitch structure aids in maintaining the fabric's shape, preventing fraying or deformation.

In summary, the closed-loop pillar stitch creates a solid, stable, and resistant fabric with a visually ordered and compact structure, wherein the stitches are closed and well interconnected.

### Jersey Stitch or “Stockinette Stitch”

This is a common knitting technique in which one side of the fabric presents a smooth surface (with the stitches “on the right side”) and the other side has a rougher appearance (with the stitches “on the wrong side”). The “jersey stitch,” or stockinette stitch, is a common knitting stitch, characterized by a structure in which the front side (the right side of the work) appears smooth and regular, while the back side (the reverse) presents a more undulating or rough appearance.

Right side: The right side of the stockinette stitch fabric is composed of a series of aligned vertical “V” shapes. Each stitch forms a small V, with the upper portion of the stitch extending downward and interlocking with the subsequent stitch. These V shapes are the result of the “knit” knitting process, wherein the yarn is pulled through the underlying loop, forming a vertically extending loop.

Reverse side: The reverse side of the fabric exhibits waves or small horizontal arches. These are the result of “reverse knitting,” where the yarn is positioned in front of the work and pulled back, forming curves. This side appears softer and more undulating than the obverse, featuring a series of small ridges running horizontally along the fabric.

Overall, the jersey stitch exhibits a regular and simple form. The stitches are arranged in ordered, parallel rows, with each row connecting to the next. Thanks to this structure, the stockinette stitch is elastic and soft, making it suitable for many types of fabrics, from dresses to accessories, such as t-shirts and sweaters.

Interconnection: In the context of seamless tubular weft-knitted fabric, the term “interconnection” refers to the manner in which the yarn loops/bushings/rings (both weft and warp) intertwine or engage with one another. This interlocking mechanism ensures that the fabric retains its structural integrity and does not fray when cut.

To further elucidate the process within the present context of this invention.

Weft bushings: These are yarn rings that run horizontally (horizontally in the attached figures) around the tubular fabric in a continuous spiral. Each weft bushing is formed by a knitting needle and constitutes a horizontal row of loops, known as a course, and hereinafter also referred to as a round where the course is spiral-shaped.

Warp rings: These are yarn loops that run vertically (vertically in the accompanying figures) along the length of the tubular fabric. Each warp ring is formed by a distinct knitting process and constitutes a component of a vertical column of loops, designated as a stitch.

Interconnection: This term describes the process by which each weft bushing engages with a warp ring. Specifically, each weft bushing of a row interlocks with a warp ring, thereby establishing a stable and secure connection. This interlocking prevents the rings from separating, even when the fabric is cut. The interconnection of the rings ensures that the fabric remains intact and does not fray, thereby conferring durability and reliability. In simpler terms, the yarn rings are envisioned as links in a chain. The interconnection process is analogous to connecting each link in a chain to another, thereby creating a robust and cohesive structure. This interlacing of rings confers strength to the fabric and prevents it from unraveling when cut.

Interlocked: This term is used as a synonym for “interconnected,” “interlaced,” or “interwoven.”

Unravel-proof: This term is used as a synonym for “does not fray” or “does not unravel.”

Weft knit rib: This term, denoted by reference 24, refers to the vertical sequence of weft bushings, belonging to the superimposed and interlaced courses or ranks.

Longitudinal component of the fabric: This component is composed of weft bushing legs 11 and 12 of weft bushing 5 and warp ring arms 15, 16, 19 of warp ring 8 (specifically: descending inner arm of warp ring 15; ascending outer arm of warp ring 16; descending outer arm of warp ring 19).

Transverse component of the fabric: This component is composed solely of the weft bushing feet 22, 23 of the weft bushing 5.

In accordance with a general embodiment, the present invention relates to a seamless tubular weft-knitted fabric 1.

In accordance with one embodiment, the present invention relates to a seamless, regularly shaped, tubular weft-knitted fabric 1, rendered unravel-proof against cutting or accidental breakage by rib knitting with independent warp chains.

A portion of this fabric comprises one or more weft ends 2, each weft end extending in a continuous weft spiral 3 forming part of the tubular knitted fabric 1 and forming a plurality of weft rows, also referred to as turns 4, arranged overlapping one another.

In accordance with one embodiment, a portion of this fabric comprises one or more weft ends 2, each weft end extending in a continuous weft spiral 3 forming part of the tubular knitted fabric 1 and forming a plurality of weft rows, also referred to as turns 4, arranged overlapping and interlocked with each other.

Each turn 4 comprises a variable plurality of weft bushings 5, for example, starting from a minimum of two.

Each weft bushing 5 of each row 4 is interconnected with a weft bushing 5 of a row 4 superimposed on this nearby position.

In accordance with one embodiment, each weft bushing 5 of each row or turn 4 is superimposed and interconnected with a weft bushing 5 of a lower row 4, and with a weft bushing 5 of a higher row 4.

The fabric 1 further comprises a plurality of warp chains 6 arranged longitudinally, parallel, and spaced apart, independent and not interlaced with each other, for example, continuously crocheted from separate warp ends 7, forming warp rings 8.

In accordance with one embodiment, the fabric 1 further comprises a plurality of warp chains 6 arranged longitudinally, parallel, and spaced apart, independent and not interlaced with each other, equal in number to the weft bushings 5 of a weft course 4, continuously crocheted from warp ends 7 separated from each other, forming wrap rings 8, more precisely referred to as “closed-loop pillar stitches.”

Each wrap ring 8 is interconnected with a weft bushing 5, ensuring that all weft bushings 5 are each interconnected with a wrap ring 8. The fabric 1 is configured to prevent unraveling upon cutting.

Thanks to this provision, the prevention of unraveling is achieved for the weft knit, since the closed-loop warp chains are inherently unravelable upon cutting.

In accordance with one embodiment, the weft bushings 5 comprise stockinette stitches or jersey stitches.

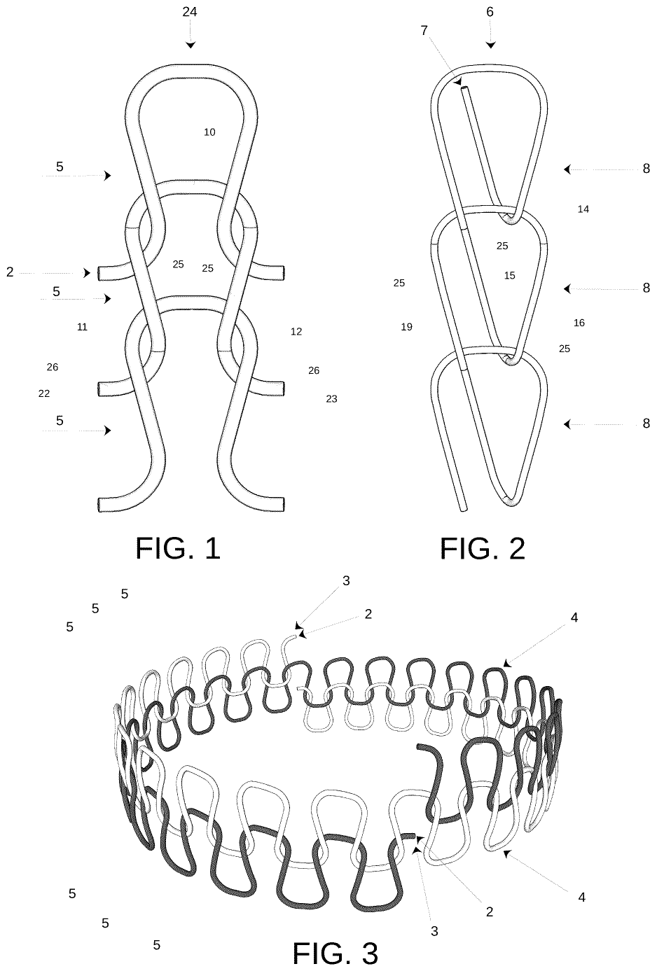

With reference to FIG. 1, in accordance with an embodiment, each weft bushing 5 is composed of a head 10, two legs 11, 12, and two feet 22, 23. The two legs 11, 12 constitute the longitudinal component 25 of the fabric of the invention, while the feet 22, 23 constitute the transverse component 26.

In accordance with one embodiment, the weft bushings 5 comprise exclusively stockinette stitches or jersey stitches.

Featuring a weft knit rib 24 composed of at least three weft bushings 5, belonging to three weft rows 4, the weft bushing 5 in the middle has the head 10 passing under the legs 11, 12 of the upper weft bushing 5, the legs 11, 12 passing over the feet 22, 23 of the upper weft bushing 5, respectively, and over the head 10 of the lower weft bushing 5, and finally its feet 22, 23 passing under the legs 11, 12 of the lower weft bushing 5, respectively.

With reference to FIG. 2, the wrap rings 8 are closed-loop pillar stitches.

With reference to FIG. 2, each warp ring 8 is composed of a descending inner arm 15, an ascending outer arm 16, a head 14, and a descending outer arm 19. The three arms 15, 16, 19 also constitute the longitudinal component 25 of the fabric of the invention, which is added to that of the weft knit.

Having a warp chain 6, defined by a warp end 7 and consisting of at least three wrap rings 8, the wrap ring 8 in the middle features the descending inner arm 15 passing beneath the head 14 of the lower wrap ring 8. It continues, after a sharp curve, with the ascending outer arm 16 passing over the head 14 of the lower warp ring 8. It proceeds with the head 14 passing under the ascending outer arm 16 of the upper warp ring 8, over the descending inner arm 15 of the upper warp ring 8, and finally under the descending outer arm 19 of the upper warp ring 8. The closed-loop pillar stitch concludes with the descending outer arm 19 passing over the head 14 of the lower warp ring 8.

In accordance with one embodiment, the invention presents a fabric wherein each warp chain 6, each generated from a separate and independent warp end 7, consisting of a vertical succession of wrap rings 8, more precisely of closed-loop pillar stitches, is interconnected and interlocked with a vertical succession of weft bushings 5, referred to as a weft knit rib 24, wherein each wrap ring 8 is interconnected and interlocked with a weft bushing 5, such that all weft bushings 5 are interconnected and interlocked with a wrap ring 8.

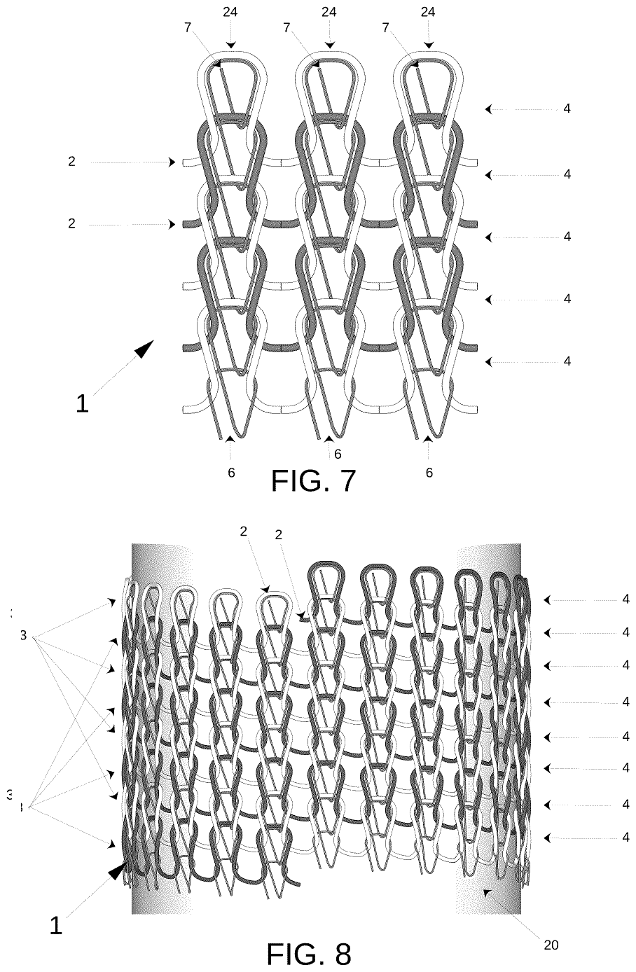

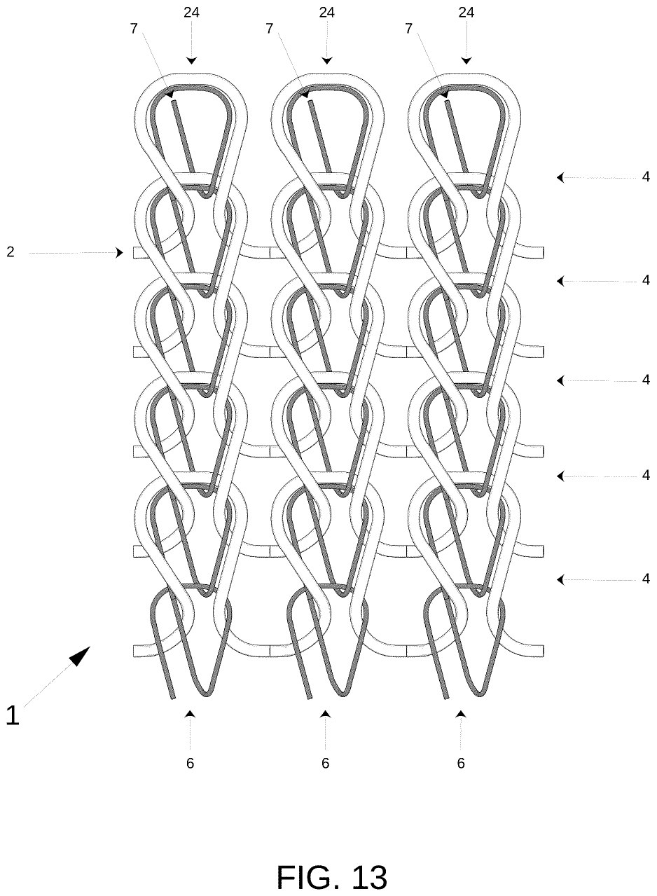

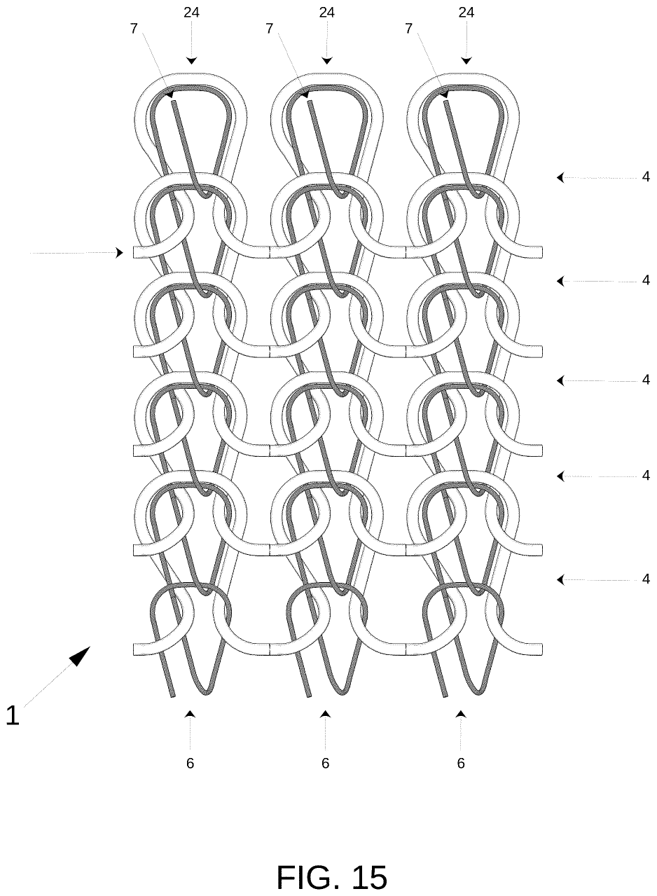

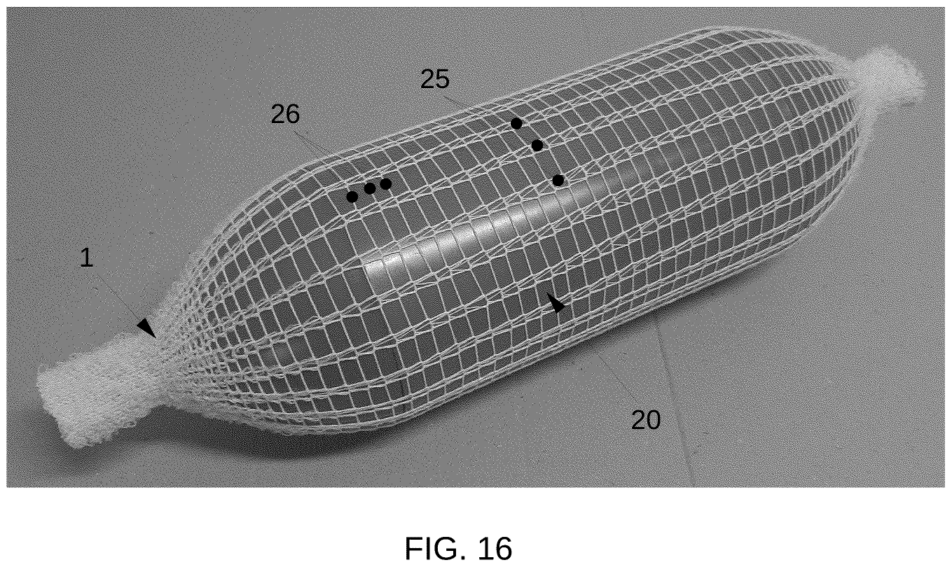

In a weft knit rib 24, each of these weft bushings 5 belongs to a different weft row 4, defined by a single weft end 2 and a single continuous weft spiral 3 (FIG. 5, FIG. 10, FIG. 13, FIG. 15), or by two or more weft ends 2 and two or more continuous weft spirals 3 (FIG. 7, FIG. 11).

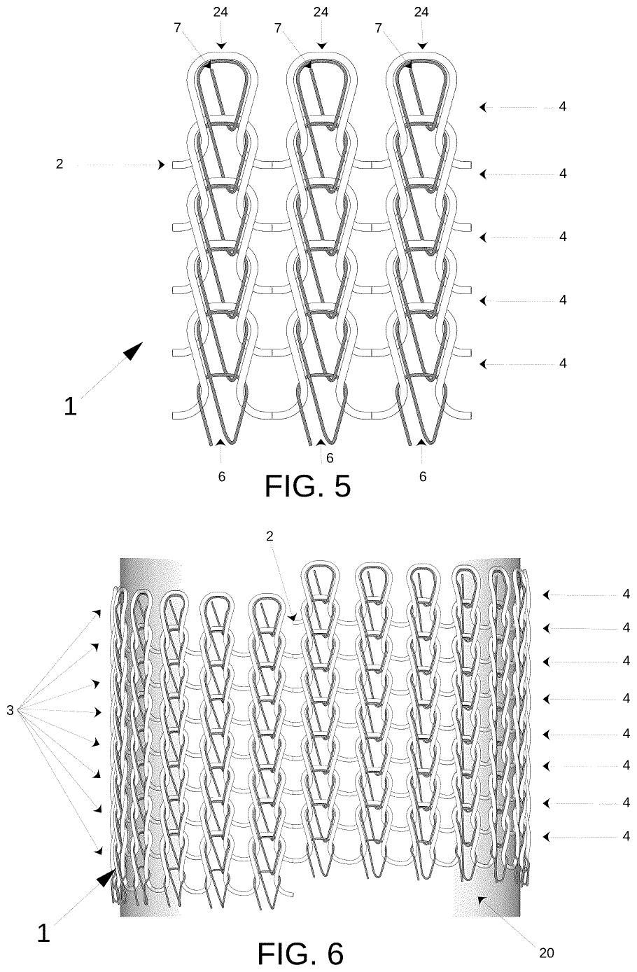

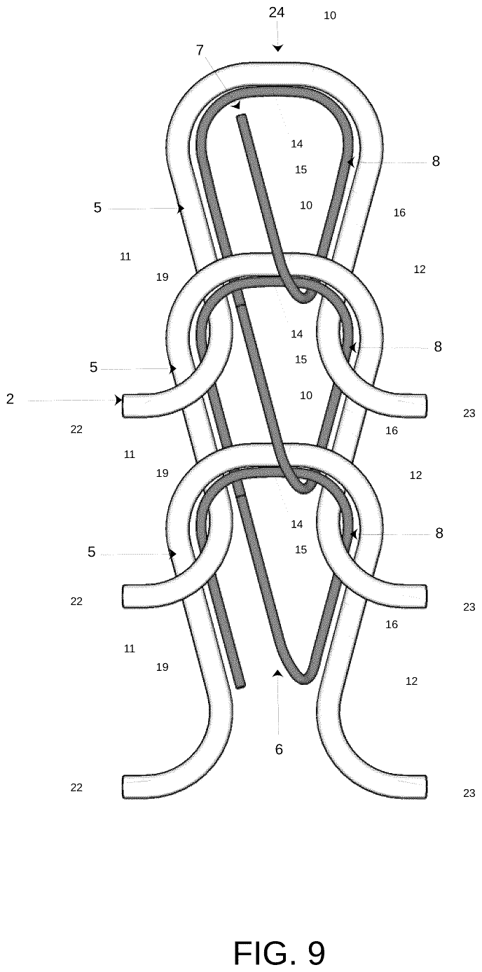

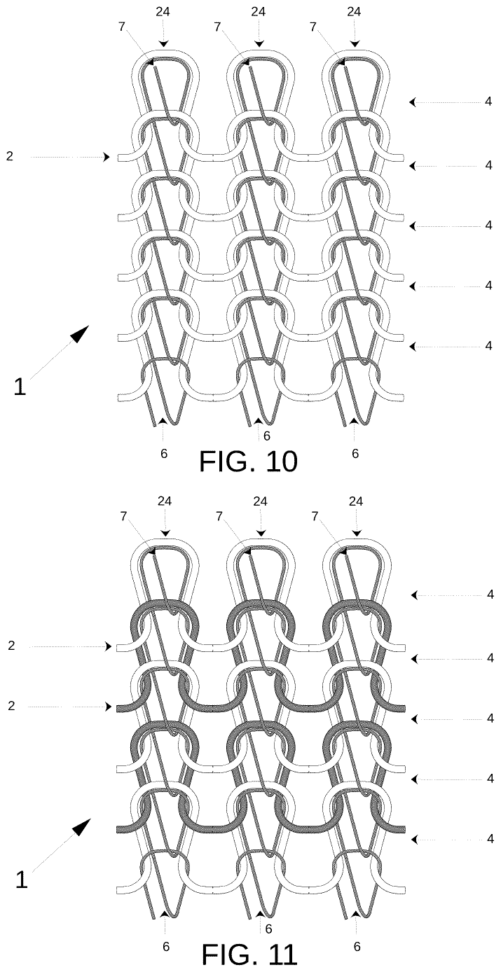

In accordance with an embodiment, for example as illustrated in FIG. 4, the interconnection between each weft knit rib 24, defined by a single weft end 2 and a single continuous weft spiral 3 (FIG. 5, FIG. 6), or by two or more weft ends 2 and two or more continuous weft spirals 3 (FIG. 7, FIG. 8), with a warp chain 6, each generated by a warp end 7 separate and independent from the others, can be described as having a weft knit rib 24 composed of at least three weft bushings 5, belonging to three weft rows 4, and a warp chain 6 composed of at least three wrap rings 8 of a single warp end 7.

Referencing warp ring 8 within warp chain 6 (FIG. 4), it features a descending inner arm 15 that passes beneath the head 10 of the lower weft bushing 5 and beneath the head 14 of the lower warp ring 8. It continues, after a sharp curve, with the ascending outer arm 16 passing first over the head 14 of the lower warp ring 8, over the head 10 of the lower weft bushing 5, and then over the foot 23 of the upper weft bushing 5. It proceeds with head 14, which first passes under the leg 12 of the upper weft bushing 5, under the ascending outer arm 16 of the upper warp ring 8, over the descending inner arm 15 of the upper warp ring 8, under the descending outer arm 19 of the upper warp ring 8, and under the leg 11 of the upper weft bushing 5. The interlacing between the warp ring 8 in the middle with the weft knit rib 24 and the remainder of the warp chain 6 concludes, with the descending outer arm 19 passing first over the foot 22 of the upper weft bushing 5, then over the head 10 of the lower weft bushing 5, and finally over the head 14 of the lower warp ring 8.

Referencing instead the weft bushing 5 in the middle of the weft knit rib 24 (FIG. 4), it presents the head 10 passing under the legs 11, 12 of the upper weft bushing 5, under the ascending outer arm 16 of the upper warp ring 8, over the descending inner arm 15 of the upper warp ring 8, and under the descending outer arm 19 of the upper warp ring 8. It then presents legs 11, 12 passing respectively over feet 22, 23 of the upper weft bushing 5, over head 10 of the lower weft bushing 5, and over head 14 of the lower warp ring 8. The weave is completed between the weft bushing 5 in the middle with the warp chain 6 and the remainder of the knitted rib in weft 24, with the feet 22, 23 passing under the arms 19, 16 of the lower warp ring 8, respectively, and under the legs 11, 12 of the lower weft bushing 5.

In accordance with an embodiment, for example as depicted in FIG. 9, the interconnection between each weft knit rib 24, defined by a single weft end 2 and a single continuous weft spiral 3 (FIG. 10), or by two or more weft ends 2 and two or more continuous weft spirals 3 (FIG. 11), with a warp chain 6, each generated by a warp end 7 separate and independent from the others, can be described as having a weft knit rib 24 composed of at least three weft bushings 5, belonging to three weft rows 4, and a warp chain 6 composed of at least three wrap rings 8 of a single warp end 7.

Referencing the warp ring 8 in the center of the warp chain 6 (FIG. 9), it features the descending inner arm 15, which passes over the head 10 of the lower weft bushing 5 and over the head 14 of the lower warp ring 8. It continues, after a sharp curve, with the ascending outer arm 16 passing first under the head 14 of the lower warp ring 8, under the head 10 of the lower weft bushing 5, and then under the foot 23 of the upper weft bushing 5. It proceeds with head 14, which first passes over the leg 12 of the upper weft bushing 5, over the ascending outer arm 16 of the upper warp ring 8, under descending inner arm 15 of the upper warp ring 8, over descending outer arm 19 of the upper warp ring 8, and over the leg 11 of the upper weft bushing 5. It concludes the interlacing between the warp ring 8 in the middle with the weft knit rib 24 and the remainder of the warp chain 6, the descending outer arm 19 passing first under the foot 22 of the upper weft bushing 5, then under the head 10 of the lower weft bushing 5, and finally under the head 14 of the lower warp ring 8.

Referencing the weft bushing 5 at the center of the weft knit rib 24 (FIG. 9), it features the head 10 passing over the legs 11, 12 of the upper weft bushing 5, over the ascending outer arm 16 of the upper warp ring 8, under the descending inner arm 15 of the upper warp ring 8, and over the descending outer arm 19 of the upper warp ring 8. It then presents legs 11, 12 passing under, respectively, the feet 22, 23 of the upper weft bushing 5, under the head 10 of the lower weft bushing 5, and under the head 14 of the lower warp ring 8. The weave is completed between the weft bushing 5 in the middle with the warp chain 6 and the remainder of the knitted rib in weft 24, with the feet 22, 23 passing over the arms 19, 16 of the lower warp ring 8, respectively, and over the legs 11, 12 of the lower weft bushing 5.

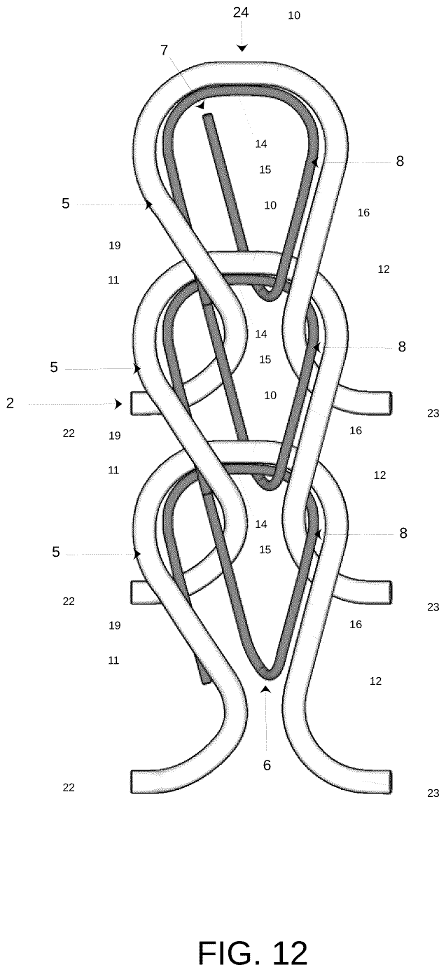

In accordance with an embodiment of FIG. 12, the interconnection between each weft knit rib 24, defined by a single weft end 2 and a single continuous weft spiral 3 (FIG. 13), with a warp chain 6, each generated by a warp end 7 separate and independent from the others, can be described by arranging a weft knit rib 24 composed of at least three weft bushings 5, belonging to three weft rows 4, and a warp chain 6 composed of at least three warp rings 8 of a single warp end 7.

Referencing the warp ring 8 within the warp chain 6 (FIG. 12), it features the descending inner arm 15, which passes over the foot 22 of the upper weft bushing 5, under the head 10 of the lower weft bushing 5, and then under the head 14 of the lower warp ring 8. Continuing, after a sharp curve, the ascending outer arm 16 passes first over the head 14 of the lower warp ring 8, over the head 10 of the lower weft bushing 5, and then over the foot 23 of the upper weft bushing 5. It proceeds with head 14, which first passes under the leg 12 of the upper weft bushing 5, under the ascending outer arm 16 of the upper warp ring 8, then over the descending inner arm 15 of the upper warp ring 8, under the leg 11 of the upper weft bushing 5, and under the descending outer arm 19 of the upper warp ring 8. The interlacing between the warp ring 8 in the middle with the weft knit rib 24 and the remainder of the warp chain 6 concludes, with the descending outer arm 19 passing first over the foot 22 of the upper weft bushing 5, under the leg 11 of the middle weft bushing 5, over the head 10 of the lower weft bushing 5, and finally over the head 14 of the lower warp ring 8.

Referencing the weft bushing 5 at the center of the weft knit rib 24 (FIG. 12), it features the head 10 passing beneath the legs 11, 12 of the upper weft bushing 5, beneath the ascending outer arm 16 of the upper warp ring 8, above the descending inner arm 15 of the upper warp ring 8, and beneath the descending outer arm 19 of the upper warp ring 8. It then presents legs 11, 12 passing respectively over the feet 22, 23 of the upper weft bushing 5, over the head 10 of the lower weft bushing 5, and over the head 14 of the lower warp ring 8. It also features the leg 11 passing over the descending outer arm 19 of warp ring 8 in the middle. The weave is completed between the weft bushing 5 in the middle with the warp chain 6 and the remainder of the knitted rib in weft 24, with the feet 22, 23 passing under the arms 19, 16 of the lower warp ring 8, respectively, and under the legs 11, 12 of the lower weft bushing 5. Furthermore, the foot 22 passes beneath the descending inner arm 15 of the lower warp ring 8.

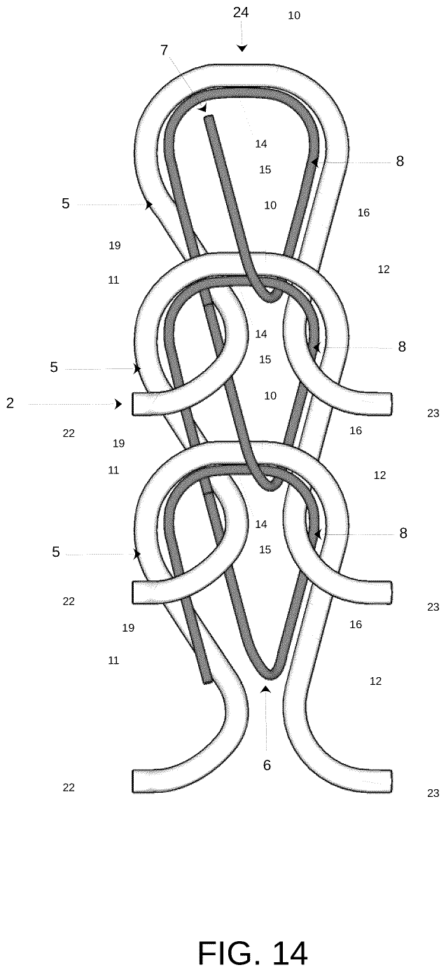

In accordance with an embodiment of FIG. 14, the interconnection between each weft knit rib 24, defined by a single weft end 2 and a single continuous weft spiral 3 (FIG. 15), with a warp chain 6, each generated by a warp end 7 separate and independent from the others, can be described as having a weft knit rib 24 composed of at least three weft bushings 5, belonging to three weft rows 4, and a warp chain 6 composed of at least three wrap rings 8 of a single warp end 7.

Referencing the warp ring 8 within the warp chain 6 (FIG. 14), it features the descending inner arm 15, which passes beneath the foot 22 of the upper weft bushing 5, above the head 10 of the lower weft bushing 5, and subsequently above the head 14 of the lower warp ring 8. It continues, following a sharp curve, with the ascending outer arm 16 passing first beneath the head 14 of the lower warp ring 8, then beneath the head 10 of the lower weft bushing 5, and finally beneath the foot 23 of the upper weft bushing 5. It proceeds with head 14, which first passes over the leg 12 of the upper weft bushing 5, over the ascending outer arm 16 of the upper warp ring 8, then under the descending inner arm 15 of the upper warp ring 8, over the leg 11 of the upper weft bushing 5, and over the descending outer arm 19 of the upper warp ring 8. The interlacing between the warp ring 8 in the middle with the weft knit rib 24 and the remainder of the warp chain 6 concludes, with the descending outer arm 19 passing first under the foot 22 of the upper weft bushing 5, over the leg 11 of the middle weft bushing 5, under the head 10 of the lower weft bushing 5, and finally under the head 14 of the lower warp ring 8.

Referencing the weft bushing 5 at the center of the weft knit rib 24 (FIG. 14), it features the head 10 passing over the legs 11, 12 of the upper weft bushing 5, over the ascending outer arm 16 of the upper warp ring 8, under the descending inner arm 15 of the upper warp ring 8, and over the descending outer arm 19 of the upper warp ring 8. It then presents legs 11, 12 passing under, respectively, the feet 22, 23 of the upper weft bushing 5, under the head 10 of the lower weft bushing 5, and under the head 14 of the lower warp ring 8. It also features the leg 11 passing beneath the descending outer arm 19 of warp ring 8 in the middle. The weave is completed between the weft bushing 5 in the middle with the warp chain 6 and the remainder of the knitted rib in weft 24, with the feet 22, 23 passing over the arms 19, 16 of the lower warp ring 8, respectively, and over the legs 11, 12 of the lower weft bushing 5. Furthermore, the foot 22 passes over the descending inner arm 15 of the lower warp ring 8.

In accordance with one embodiment, one or more weft ends or weft yarns 2 are made of elastic yarn.

In accordance with one embodiment, one or more weft ends 2 are formed from one or more elastic threads of multiple and differing characteristics of nature, thickness, and elasticity, covered by spiraling with one or more non-elastic threads of various natures and thicknesses.

In accordance with one embodiment, the longitudinal warp chains or warp yarns 6 are made of substantially non-elastic yarn.

In accordance with one embodiment, the longitudinal warp chains 6, each comprising a warp end 7, are formed from one or more substantially inelastic yarns of multiple and differing characteristics of nature and thickness.

In accordance with one embodiment, each weft end 2 is comprised of multiple weft yarns possessing distinct elastic characteristics.

In accordance with one embodiment, each warp chain 6 is comprised of multiple warp yarns possessing distinct characteristics.

In accordance with one embodiment, the fabric 1 is utilized as a net for sausages.

In accordance with one embodiment, the fabric 1 is utilized as a net for the packaging of meat and sausages 20, necessary for wrapping and containing such products during the cooking and curing processes.

The present invention also relates to a method for producing a seamless tubular weft-knitted fabric 1, the method comprising at least the following steps:
providing one or more weft ends 2;
extending each weft end 2 in a continuous spiral 3, forming a portion of a tubular knitted fabric 1 to create a plurality of overlapping rows or turns 4, each turn 4 comprising a plurality of weft bushings 5, each weft bushing 5 of each turn 4 being interconnected with a neighboring weft bushing 5 of a neighboring overlapping turn 4;
providing a plurality of warp ends 7; continuously crocheting the plurality of warp ends 7 into longitudinal, parallel, and spaced warp chains 6, not interlaced with each other; the longitudinal warp chains 6 being formed from warp ends 7 separated from each other to form wrap rings 8; and
interconnecting each wrap ring 8 with a weft bushing 5 so that all weft bushings 5 are interconnected with a wrap ring 8.

This seamless tubular weft knitted fabric 1, thus produced, is configured to prevent unraveling when cut.

In accordance with one embodiment of the method, the weft bushings 5 are formed in a Jersey stitch or stockinette stitch.

In accordance with one embodiment of the method, the wrap rings 8 are formed by chain stitches of closed pillar stitches.

In accordance with one embodiment of the method, one or more weft ends 2 are formed from elastic yarn.

In accordance with one embodiment of the method, the longitudinal warp chains 6 are formed from substantially non-elastic yarn.

In accordance with one embodiment of the method, each weft end or thread 2 is comprised of multiple weft threads possessing distinct elastic characteristics.

In accordance with one embodiment of the method, each end or warp yarn 7 is comprised of multiple warp yarns possessing distinct characteristics.

In accordance with one embodiment of the method, the seamless tubular weft-knitted fabric 1 is utilized as a net for wrapping and containing sausages.

In accordance with one embodiment of the method, the seamless tubular weft-knitted fabric 1 is utilized as a net for packaged products.

The present invention also relates to a seamless, regularly shaped, tubular weft knitted fabric 1 for packaging meat or sausage products 20 during cooking or curing processes, comprising: one or more weft ends 2, each weft end 2 extending in a continuous spiral 3 forming a portion of the tubular weft knitted fabric 1, forming a plurality of overlapping rows 4, each row 4 comprising a plurality of weft bushings 5, wherein each weft bushing 5 of each weft row 4 is superimposed and interconnected with an upper weft bushing 5 and with a lower weft bushing 5 of a neighboring and overlapping row 4, forming vertical rows of weft bushings 5, referred to as weft knitted ribs 24; a plurality of parallel and spaced longitudinal warp chains 6, equal in number to the weft bushings 5 of a weft row 4, continuously crocheted from separate and independent warp ends 7, forming wrap rings 8, more precisely referred to as closed-loop pillar stitches; wherein each wrap ring 8 of a weft knitted rib 24 is interconnected with a weft bushing 5 of a warp chain 6, so that all weft bushings 5 are interconnected and interlocked with a wrap ring 8, and wherein the tubular weft knitted fabric 1 is configured to prevent unraveling when cut.

The present invention also relates to a processed meat-based product 20 enclosed within a seamless tubular weft-knitted fabric 1, in accordance with any of the embodiments described above.

The present invention also relates to a processed meat-based product 20 enclosed within a seamless tubular weft-knitted fabric 1, manufactured according to any method and any of the embodiments described above.

The seamless tubular weft-knitted fabric of the present invention is specifically designed to prevent unraveling upon cutting.

This innovative fabric is particularly suitable for applications such as sausage netting and other packaging solutions, where maintaining the product's shape and integrity is paramount.

The fabric is constructed with one or more weft ends extending in a continuous spiral, forming a tubular knitted fabric and a plurality of overlapping turns. Each turn is composed of multiple weft bushings, with each weft bushing engaging a neighboring ring of a nearby overlapping spiral turn.

If left unaddressed, this interconnection would be essential for maintaining the structural integrity of the fabric and preventing unraveling upon cutting.

Furthermore, the fabric comprises a plurality of parallel, spaced-apart longitudinal warp chains (relative to the tubular knitted fabric), which are continuously crocheted from separate warp ends to form wrap rings.

Each wrap ring engages a weft bushing, ensuring that all weft bushings are securely interconnected with a wrap ring.

The weft bushings in the fabric are formed using the jersey stitch technique, a knitting technique known for its flexibility and strength.

The wrap rings, on the other hand, are formed by closed pillar stitch chain stitches, also known as closed-loop pillar stitches, which contribute to the overall stability and integrity of the fabric. This combination of knitting techniques ensures that the fabric remains intact and does not unravel, even when cut.

In accordance with an embodiment of this fabric, elastic yarn is utilized for one or more weft ends. This enhances the fabric's flexibility and its capacity to conform to diverse shapes, rendering it suitable for a broad spectrum of applications.

In accordance with one embodiment, the longitudinal warp chains are formed from substantially inelastic yarn, thereby imparting stability and strength to the fabric.

Furthermore, in accordance with an embodiment, the fabric can be customized using multiple weft and warp yarns with different characteristics, allowing for tailored performance and behavior to meet specific requirements.

The seamless tubular weft knitted fabric is particularly advantageous for use as a net for sausages. In the sausage industry, it is essential to maintain the product's shape during the curing process, and this fabric addresses this need by preventing unraveling when cut. The fabric can also be utilized as a net for other packaged products, underscoring its versatility and utility across diverse contexts.

Advantageously, this fabric can be produced separately from the bagging process, threaded onto the bagging machines, and cut to size during the production of the bagged product, without the fabric fraying.

### Method of Production

The method for producing this seamless tubular weft knitted fabric comprises several key steps.

Firstly, one or more weft ends are provided and extended in a continuous spiral, forming a tubular knitted fabric to create overlapping turns.

Each turn comprises multiple weft bushings, with each weft bushing engaging a neighboring loop of a previously formed, adjacent, overlapping turn.

Simultaneously, a plurality of parallel, spaced-apart longitudinal warp chains, thereby not interlaced with one another, are provided and continuously crocheted from separate warp ends to form wrap rings.

Each wrap ring is then secured to a weft bushing of the same weft spiral turn, ensuring that all weft bushings are firmly interconnected with a wrap ring.

This method ensures that the fabric is configured to prevent unraveling when cut.

The weft bushings in the method are formed with stockinette stitch, while the wrap rings are formed by closed pillar chain stitches.

In accordance with one embodiment of the method, the method also includes the use of elastic yarn for one or more weft ends, and the longitudinal warp chains are made of substantially non-elastic yarn.

In accordance with an embodiment of the method, it is possible to utilize multiple weft and warp yarns possessing distinct characteristics, thereby enabling the customization of the fabric's properties.

The seamless tubular weft-knitted fabric produced by this method is suitable for use as a net for sausages and other packaged products, providing a reliable and durable solution for various packaging requirements.

### Technical Effects

The seamless tubular weft-knitted fabric described herein offers numerous noteworthy advantages. The primary advantage resides in its capacity to prevent unraveling upon cutting, thereby addressing a significant limitation of traditional mesh products. This feature enables the fabric to be produced independently of the packaging process, resulting in a more efficient and cost-effective production workflow.

The interconnection of the weft and wrap rings ensures that the fabric maintains its structural integrity, providing a reliable solution for applications such as sausage netting and other packaging requirements.

Furthermore, the combined use of elastic and non-elastic yarns enhances the fabric's versatility and performance. Elastic yarns contribute to the fabric's flexibility and its ability to conform to various shapes, while non-elastic yarns provide stability and strength. This combination enables the customization of the fabric's properties to meet specific requirements, rendering it suitable for a wide range of applications.

The seamless construction further ensures a uniform and consistent product, thereby reducing the likelihood of defects and improving overall quality.

What is claimed is:

1. A seamless tubular weft-knitted fabric comprising:
one or more weft ends, each of the one or more weft ends extending in a continuous weft spiral and forming a plurality of courses arranged mutually superimposed, wherein each course comprises a plurality of weft bushings, wherein each weft bushing of the plurality of weft bushings of each course is interconnected to a neighboring weft bushing of a neighboring superimposed course; and
a plurality of warp chains placed mutually longitudinally parallel and spaced apart, not mutually interconnected, each warp chain of the plurality of warp chains being continuously crocheted by an independent warp end into a plurality of wrap rings,
wherein each wrap ring is interconnected to a respective weft bushing, so that each of the weft bushings is also interconnected to a respective wrap ring, and
wherein the seamless tubular weft-knitted fabric is configured to prevent run-outs when the seamless tubular weft-knitted fabric is cut.

2. The seamless tubular weft-knitted fabric of claim 1, wherein
the weft bushings comprise stockinette stitches or jersey stitches;
or wherein
the weft bushings exclusively comprise stockinette stitches or jersey stitches;
and/or wherein
each weft bushing has a weft bushing head, two weft bushing legs, and two weft bushing feet;
and/or wherein
each weft bushing has a weft bushing head two weft bushing legs, and two weft bushing feet, and wherein, when the plurality of courses comprises at least three courses each intermediate weft bushing of an intermediate course in the middle has a respective weft bushing head that passes under the weft bushing legs of an adjacent upper weft bushing of an upper course, wherein the weft bushing legs of each intermediate weft bushing pass over respective weft bushing feet of an adjacent upper weft bushing and over the respective weft bushing head of an adjacent lower weft bushing of a lower course, respectively, and the weft bushing feet of each intermediate weft bushing pass under the respective weft bushing legs of an adjacent lower weft bushing;
or wherein
each weft bushing has a weft bushing head, two weft bushing legs, and two weft bushing feet, and wherein, when the plurality of courses comprises at least three courses, each intermediate weft bushing of an intermediate course in the middle has a respective weft bushing head that passes over the weft bushing legs of an adjacent upper weft bushing of an upper course, wherein the weft bushing legs of each intermediate weft bushing pass under respective weft bushing feet of an adjacent upper weft bushing and under the respective weft bushing head of an adjacent lower weft bushing of a lower course, respectively, and the weft bushing feet of each intermediate weft bushing pass over the respective weft bushing legs of an adjacent lower weft bushing.

3. The seamless tubular weft-knitted fabric of claim 2, wherein the seamless tubular weft-knitted fabric comprises at least one of the following features:
the wrap rings are formed by chain stitches of closed-course pillar stitches;
and/or wherein
each wrap ring comprises an inner descending wrap ring arm, an outer ascending wrap ring arm, a wrap ring head and an outer descending wrap ring arm;
and/or wherein
each wrap ring, comprises an inner descending wrap ring arm, an outer ascending wrap ring arm, a wrap ring head, and an outer descending wrap ring arm, and
each warp chain comprises at least three wrap rings, wherein a middle the wrap ring has a respective inner descending wrap ring arm that passes under the wrap ring head of a lower wrap ring, wherein the inner descending wrap ring arm of the middle wrap ring continues, after a tight bend, to form the outer ascending wrap ring arm of the middle wrap ring, which passes over the wrap ring head of said the lower wrap ring and continues to form the wrap ring head of the middle wrap ring, which passes under the outer ascending wrap ring arm of an upper wrap ring, passing over the inner descending wrap ring arm of the upper wrap ring, and then under the outer descending wrap ring arm of the upper wrap ring, closing a closed-course pillar stitch, and the outer descending wrap ring arm of the upper wrap ring. which passes over the wrap ring head of the lower wrap ring; or
each warp chain is interconnected to a sequence of weft bushings, wherein each of the weft bushings belongs to a different course.

4. The seamless tubular weft-knitted fabric claim 3, wherein
an interconnection between (i) each weft-knitted rib, defined by a single weft end and a single continuous weft spiral, or by two or more weft ends and two or more continuous weft spirals, and (ii) a warp chain of the plurality of warp chains, each warp chain generated by a separate warp end independent of the other warp ends, comprises a weft-knitted rib comprising at least three weft bushings, belonging to three respective courses, and a warp chain comprising at least three wrap rings of a single warp end, and wherein
taking as a reference the wrap ring in the middle of the warp chain, the middle wrap ring has a respective inner descending wrap ring arm that passes under the weft bushing head of a lower weft bushing of the at least three weft bushings, and under the wrap ring head of the lower wrap ring and, after a tight bend, with the outer ascending wrap ring arm of the middle wrap ring. passes first over the wrap ring head of the lower wrap ring, over the weft bushing head of the lower weft bushing and then over a respective one of the weft bushing feet of an upper weft bushing of the at least three weft bushings and continues with the wrap ring head of the middle wrap ring. which passes first under a respective one of the weft bushing legs of the upper weft bushing, under the outer ascending wrap ring arm of the upper wrap ring over the inner descending wrap ring arm of the upper wrap ring, under the outer descending wrap ring arm of the upper wrap ring and under the other of the weft bushing legs of the upper weft bushing, and
the middle wrap ring completes interlacing between the middle wrap ring with the weft-knitted rib and a rest of the warp chain, the outer descending wrap ring arm passing first over the other of the weft bushing feet of the upper weft bushing, then over the weft bushing head of the lower weft bushing, and then over the wrap ring head of the lower wrap ring.

5. The seamless tubular weft-knitted fabric of claim 3, wherein
taking as a reference a middle weft bushing in a middle of at least three weft bushings of a weft-knitted rib, the weft-knitted rib being defined by a single weft end and a single continuous weft spiral, or by two or more weft ends and two or more continuous weft spirals, interconnected with a warp chain of the plurality of warp chains, each warp chain generated by a separate warp end independent of the other warp ends, the weft-knitted rib comprises a weft-knitted rib comprising the at least three weft bushings, belonging to three respective courses, and a warp chain comprising at least three wrap rings of a single warp end, wherein
the middle weft bushing has a respective weft bushing head passing under the weft bushing legs of an upper weft bushing of the at least three weft bushings, under the outer ascending wrap ring arm of the upper wrap ring, over the inner descending wrap ring arm of the upper wrap ring, and under the outer descending wrap ring arm of the upper wrap ring and wherein
the weft bushing legs of the middle weft bushing pass over the weft bushing feet of the upper weft bushing, over the weft bushing head of a lower weft bushing of the at least three weft bushings, and over the wrap ring head of the lower wrap ring, respectively; and wherein
the weft bushing legs of the middle weft bushing complete interlacing between the middle weft bushing with the warp chain and a rest of the weft-knitted rib, the weft bushing feet of the middle weft bushing passing under the outer descending and outer ascending wrap ring arms of the lower wrap ring and under the weft bushing legs of the lower weft bushing, respectively.

6. The seamless tubular weft-knitted fabric of claim 3, wherein
an interconnection between (i) each weft-knitted rib, defined by a single weft end and a single continuous weft spiral, or by two or more weft ends and two or more continuous weft spirals and (ii) a warp chain of the plurality of warp chains, each warp chain generated by a separate warp end independent of the other warp ends, comprises a weft-knitted rib comprising at least three weft bushings, belonging to three respective courses, and a warp chain comprising at least three wrap rings of a single warp end, wherein
taking as a reference the middle wrap ring in a middle of the warp chain, the middle wrap ring has a respective inner descending wrap ring arm that passes over the weft bushing head of a lower weft bushing of the at least three weft bushings, and over the wrap ring head of the lower wrap ring and continues, after a tight bend, with the outer ascending wrap ring arm that passes first under the wrap ring head of the lower wrap ring under the weft bushing head of the lower weft bushing, and then under a respective one of the weft bushing feet of an upper weft bushing of the at least three weft bushings, wherein
the middle wrap ring continues with the wrap ring head passing first over a respective one of the weft bushing legs of the upper weft bushing, over the outer ascending wrap ring arm of the upper wrap ring, under the inner descending wrap ring arm of the upper wrap ring, over the outer descending wrap ring arm of the upper wrap ring, and over the other of the weft bushing legs of the upper weft bushing, and wherein
the middle wrap ring completes interlacing between the middle wrap ring with the weft-knitted rib and a rest of the warp chain, the outer descending wrap ring arm passing first under the other of the weft bushing feet of the upper weft bushing, then under the weft bushing head of the lower weft bushing, and finally under the wrap ring head of the lower wrap ring.

7. The seamless tubular weft-knitted fabric one of claim 6, wherein
taking as a reference a middle weft bushing of the at least three weft bushings in a middle of the weft-knitted rib,
the middle weft bushing has a respective weft bushing head that passes over the weft bushing legs of the upper weft bushing over the outer ascending wrap ring arm of the upper wrap ring, under the inner descending wrap ring arm of the upper wrap ring, and over the outer descending wrap ring arm of the upper wrap ring, wherein
the weft bushing legs of the middle weft bushing pass under the weft bushing feet of the upper weft bushing, under the weft bushing head of the lower weft bushing, and under the wrap ring head of the lower wrap ring, respectively, and wherein
the weft bushing legs of the middle weft bushing complete interlacing between the middle weft bushing and a rest of the weft-knitted rib, the weft bushing feet passing over the outer descending and outer ascending wrap ring arms of the lower wrap ring, and over the weft bushing legs of the lower weft bushing, respectively.

8. The seamless tubular weft-knitted fabric of claim 3, wherein
an interconnection between (i) each weft-knitted rib, defined by a single weft end and a single continuous weft spiral and (ii) a warp chain of the plurality of warp chains, each warp chain generated by a separate warp end independent of the other warp ends, comprises a weft-knitted rib comprising at least three weft bushings, belonging to three respective courses, and a warp chain comprising at least three wrap rings of a single warp end; wherein
taking as a reference the middle wrap ring, the middle wrap ring has a respective inner descending wrap ring arm that passes over a respective one of the weft bushing feet of an upper weft bushing of the at least three weft bushings, under the weft bushing head of a lower weft bushing of the at least three weft bushings, and then under the wrap ring head of the lower wrap ring, wherein
the middle wrap ring continues, after a tight bend, with a respective outer ascending wrap ring arm that passes first over the wrap ring head of the lower wrap ring, over the weft bushing head of the lower weft bushing, and then over a respective one of the weft bushing feet of the upper weft bushing, wherein
the middle wrap ring continues with a respective wrap ring head that passes first under a respective one of the weft bushing legs of the upper weft bushing, under the outer ascending wrap ring arm of the upper wrap ring, then over the inner descending wrap ring arm of the upper wrap ring, under the other of the weft bushing legs of the upper weft bushing, and under the outer descending wrap ring arm of the upper wrap ring, and wherein
the middle wrap ring completes interlacing between the middle wrap ring and a rest of the warp chain, the outer descending wrap ring arm passing first over the one of the weft bushing feet of the upper weft bushing, under one of the weft bushing legs of the middle weft bushing, over the weft bushing head of the lower weft bushing, and finally over the wrap ring head of the lower wrap ring.

9. The seamless tubular weft-knitted fabric of claim 8, wherein
taking as a reference the middle weft bushing; wherein
the middle weft bushing has a respective weft bushing head that passes under the weft bushing legs of the upper weft bushing, under the outer ascending wrap ring arm of the upper wrap ring over the inner descending wrap ring arm of the upper wrap ring, and under the outer descending wrap ring arm of the upper wrap ring, wherein
the weft bushing legs of the middle weft bushing pass over the weft bushing feet of the upper weft bushing, over the weft bushing head of the lower weft bushing, and over the wrap ring head of the lower wrap ring, respectively, wherein
one of the weft bushing legs of the middle weft bushing passes over the outer descending wrap ring arm of the middle wrap ring, and wherein
the weft bushing legs of the middle weft bushing complete interlacing between the middle weft bushing with the warp chain and a rest of the weft-knitted rib, the weft bushing feet of the middle weft bushing passing under the outer descending and outer ascending wrap ring arms of the lower wrap ring, and under the weft bushing legs of the lower weft bushing, respectively, and wherein
one of the weft bushing feet of the middle weft bushing passes under the inner descending wrap ring arm of the lower wrap ring.

10. The seamless tubular weft-knitted fabric claim 3, wherein
an interconnection between (i) each weft-knitted rib, defined by a single weft end and a single continuous weft spiral, and (ii) a warp chain of the plurality of warp chains, each warp chain generated by a separate warp end independent of the other warp ends, comprises a weft-knitted rib comprising at least three weft bushings, belonging to three respective courses, and a warp chain comprising at least three wrap rings of a single warp end; wherein
taking as a reference the middle wrap ring, the middle wrap ring has a respective inner descending wrap ring arm that passes under a respective one of the weft bushing feet of an upper weft bushing of the at least three weft bushings, over the weft bushing head of a lower weft bushing of the at least three weft bushings, and then over the wrap ring head of the lower wrap ring, wherein
the middle wrap ring continues, after a tight bend, with the outer ascending wrap ring arm of the middle wrap ring passing first under the wrap ring head of the lower wrap ring, under the weft bushing head of the lower weft bushing, and then under the other of the weft bushing feet of the upper weft bushing, wherein
the middle wrap ring continues with the wrap ring head of the middle wrap ring passing first over a respective one of the weft bushing legs of the upper weft bushing, over the outer ascending wrap ring arm of the upper wrap ring, then under the inner descending wrap ring arm of the upper wrap ring over the other of the weft bushing legs of the upper weft bushing, and over the outer descending wrap ring arm of the upper wrap ring, and wherein
the middle wrap ring completes interlacing between the middle wrap ring with the weft-knitted rib and a rest of the warp chain, the outer descending wrap ring arm of the middle wrap ring passing first under the one of the weft bushing feet of the upper weft bushing, over a respective one of the weft bushing legs of a middle weft bushing of the at least three bushings, under the weft bushing head of the lower weft bushing and under the wrap ring head of the lower wrap ring.

11. The seamless tubular weft-knitted fabric of claim 10, wherein
taking instead as a reference the middle weft bushing; wherein
the middle weft bushing in the middle has a respective weft bushing head that passes over the weft bushing legs of the upper weft bushing, over the outer ascending wrap ring arm of the upper wrap ring, under the inner descending wrap ring arm of the upper wrap ring and over the outer descending wrap ring arm of the upper wrap ring, wherein
the weft bushing legs of the middle weft bushing pass under the weft bushing feet of the upper weft bushing, under the weft bushing head of the lower weft bushing, and under the wrap ring head of the lower wrap ring, respectively, and wherein
the one of the weft bushing legs of the middle weft bushing passes under the outer descending wrap ring arm of the wrap ring in the middle, wherein
the weft bushing legs of the middle weft bushing complete interlacing between the middle weft bushing with the warp chain and the rest of the weft-knitted rib, the weft bushing feet of the middle weft bushing passing over the outer descending and outer ascending wrap ring arms of the lower wrap ring, and over the weft bushing legs of the lower weft bushing, respectively, and wherein
a respective one of the weft bushing feet of the middle weft bushing passes over the inner descending wrap ring arm of the lower wrap ring.

12. The seamless tubular weft-knitted fabric of claim 1, wherein the one or more weft ends are made of an elastic yarn.

13. The seamless tubular weft-knitted fabric of claim 1, wherein the warp chains are made of a substantially non-elastic yarn.

14. The seamless tubular weft-knitted fabric of claim 1, wherein the one or more weft ends each comprise multiple weft yarns with different elastic features.

15. The seamless tubular weft-knitted fabric of claim 1, wherein each warp chain comprises multiple warp yarns with different elastic features.

16. The seamless tubular weft-knitted fabric of claim 1, wherein the seamless tubular weft-knitted fabric is used as a net for cured meat.

17. A method for producing a seamless tubular weft-knitted fabric, the method comprising:
providing one or more weft ends;
extending the one or more weft ends into a continuous spiral for forming a plurality of superimposed courses, each course of the plurality of superimposed courses comprising a plurality of weft bushings, each weft bushing of the plurality of weft bushings of each course being interconnected to a neighboring weft bushing of a neighboring superimposed course;
providing a plurality of warp ends;
continuously crocheting the plurality of warp ends into longitudinally parallel warp chains spaced apart from one another and not mutually interconnected, the longitudinally parallel warp chains being formed by mutually separated warp ends into wrap rings; and
interconnecting each of the wrap rings with a respective weft bushing of the plurality of weft bushings so that each of the weft bushings is also interconnected to a respective wrap ring,
wherein the seamless tubular weft-knitted fabric is configured to prevent run-outs when the seamless tubular weft-knitted fabric is cut.

18. The method of claim 17, further comprising using the seamless tubular weft-knitted fabric as a net for wrapping and containing cured meat.

19. The method of claim 17, further comprising using the seamless tubular weft-knitted fabric as a net for bagged products.

20. A seamless tubular weft-knitted fabric for processed meat-based products, comprising:
one or more weft ends, each of the one or more weft ends extending into a continuous spiral to form a plurality of superimposed courses, each course of the plurality of superimposed courses comprising a plurality of weft bushings, each weft bushing of the plurality of weft bushings of each course being interconnected to a neighboring weft bushing of a neighboring superimposed course;
a plurality of longitudinally parallel warp chains spaced apart from one another and crocheted continuously from separate warp ends, to form a plurality of wrap rings;
wherein each of the plurality of wrap rings is interconnected to a respective weft bushing of the plurality of weft bushings so that each of the weft bushings is also interconnected to a respective wrap ring, and
wherein the seamless tubular weft-knitted fabric is configured to prevent run-outs when the seamless tubular weft-knitted fabric is cut.

21. A processed meat-based product enclosed in the seamless tubular weft-knitted fabric of claim 1.

22. A processed meat-based product enclosed in the seamless tubular weft-knitted fabric made according to the method of claim 17.
